(19) United States
(12) Patent Application Publication
(10) Pub. No.: US 2022/0415093 A1
(43) Pub. Date: Dec. 29, 2022

(54) METHOD AND SYSTEM FOR RECOGNIZING FINGER LANGUAGE VIDEO IN UNITS OF SYLLABLES BASED ON ARTIFICIAL INTELLIGENCE

(71) Applicant: Korea Electronics Technology Institute, Seonganm-si (KR)

(72) Inventors: Han Mu PARK, Seongnam-si (KR); Jin Yea JANG, Suwon-si (KR); Sa Im SHIN, Seoul (KR)

(73) Assignee: Korea Electronics Technology Institute, Seonganm-si (KR)

(21) Appl. No.: 17/851,639

(22) Filed: Jun. 28, 2022

(30) Foreign Application Priority Data
Jun. 29, 2021 (KR) 10-2021-0084670

(51) Int. Cl. G06V 40/20; G06V 10/774; G06V 20/40; G06V 40/10

(52) U.S. Cl. CPC G06V 40/28; G06V 10/774; G06V 20/40; G06V 40/10

(57) ABSTRACT

There are provided a method and a system for recognizing a finger language video in units of syllables based on AI. The finger language video recognition system includes: an extraction unit configured to extract posture information of a speaker from a finger language video; and a recognition unit configured to recognize a finger language of the speaker from the extracted posture information of the speaker in units of syllables, and to output a text. Accordingly, a language text in units of syllables may be generated from a finger language video, by using an AI-based syllable unit finger language recognition model.

### CROSS-REFERENCE TO RELATED APPLICATION(S) AND CLAIM OF PRIORITY

This application is based on and claims priority under 35 U.S.C. § 119 to Korean Patent Application No. 10-2021-0084670, filed on Jun. 29, 2021, in the Korean Intellectual Property Office, the disclosure of which is herein incorporated by reference in its entirety.

### BACKGROUND

### Field

The disclosure relates to artificial intelligence (AI) technology, and more particularly, to a method and a system for analyzing a finger language video by using an AI model and translating into words.

### Description of Related Art

Finger language in sign languages is a method of representing alphabets, numbers one by one by using fingers. This is used to represent words that are not defined by sign languages, by using the hands.

Recently, there are attempts to recognize sign languages by using AI technology, which includes recognition of finger language. According to a related-art method, an input of an image is received and finger language is recognized in units of phonemes.

However, when sign language is recognized based on an image, not based on a video, the relation between positions of the hand for expressing onset/nucleus/coda may not be used, and accordingly, accuracy of recognition may be degraded, and also, there may be a problem that utterance of finger language is not continuously recognized.

### SUMMARY

The disclosure has been developed to address the above-discussed deficiencies of the prior art, and an object of the present disclosure is to provide a method and a system for converting a finger language video into a language text by using an AI-based syllable unit finger language recognition model.

According to an embodiment of the disclosure to achieve the above-described object, a finger language video recognition system includes: an extraction unit configured to extract posture information of a speaker from a finger language video; and a recognition unit configured to recognize a finger language of the speaker from the extracted posture information of the speaker in units of syllables, and to output a text.

The posture information of the speaker may be a skeleton model which is expressed by positions of feature points of face, hands, arms, and body of the speaker.

The recognition unit may recognize the finger language of the speaker from the posture information of the speaker, by using an AI model which receives an input of posture information of a speaker, recognizes a finger language of the speaker in units of syllables, and outputs a text.

According to an embodiment of the disclosure, the finger language video recognition system may further include a learning unit configured to train the AI model, and the learning unit may include: an extraction unit configured to extract posture information of a speaker from a finger language video for training; and a processing unit configured to process data into training data for training the AI model by using the extracted posture information.

The processing unit may augment the posture information of the speaker, may combine with a finger language word in units of syllables, and may process data into training data.

The learning unit may further include a generator configured to generate virtual training data by utilizing a finger language word in units of syllables.

In addition, the generator may include a first module configured to change an order of syllables forming a finger language word, and to generate virtual training data by combining matched posture information.

In addition, the generator may include a second module configured to delete some of syllables forming a finger language word, and to generate virtual training data by combining matched posture information.

The generator may include a third module configured to add a new syllable to a finger language word, and to generate virtual training data by combining matched posture information.

According to another embodiment of the disclosure, a finger language video recognition method includes: extracting posture information of a speaker from a finger language video; and recognizing a finger language of the speaker from the extracted posture information of the speaker in units of syllables, and outputting a text.

According to another embodiment, a finger language video recognition system includes: a recognition unit configured to recognize a finger language of a speaker from a finger language video in units of syllables, by using an AI model, and to output a text; and a learning unit configured to train the AI model.

According to another embodiment, a finger language video recognition method includes: training an AI model which recognizes a finger language of a speaker from a finger language video in units of syllables, and outputs a text; and recognizing a finger language of a speaker from a finger language video in units of syllables, by using an AI model, and outputting a text.

According to embodiments of the disclosure as described above, a language text in units of syllables may be generated from a finger language video, by using an AI-based syllable unit finger language recognition model.

In addition, according to embodiments of the disclosure, data for training a finger language recognition model is processed and virtual training data is additionally generated, so that accuracy of recognition of the finger language recognition model is further enhanced.

### BRIEF DESCRIPTION OF THE DRAWINGS

FIG. 1 is a view illustrating a structure of a syllable unit finger language video recognition system according to an embodiment of the disclosure;

FIG. 2 is a view illustrating joint structures of face, body, and hand;

FIG. 3 is a view illustrating a structure of a syllable unit finger language recognition model;

FIG. 4 is a view illustrating a structure of a training data processing unit;

FIG. 5 is a view illustrating a structure of a training data generator; and

FIG. 6 is a view illustrating a hardware structure for implementing a syllable unit finger language video recognition system according to an embodiment of the disclosure.

### DETAILED DESCRIPTION

Hereinafter, the disclosure will be described in detail with reference to the accompanying drawings.

It is appropriate to recognize finger language in units of syllables having meanings rather than in units of phonemes. Accordingly, an embodiment of the disclosure provides a method for recognizing finger language in units of syllables in a finger language video based on AI.

In addition, an embodiment of the disclosure provides a method for augmenting training data which is insufficient to train an AI model for recognizing finger language.

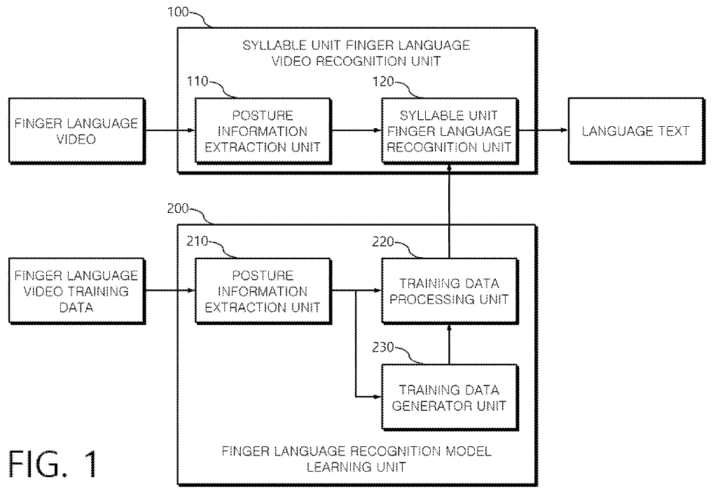

FIG. 1 is a view illustrating a structure of a syllable unit finger language video recognition system according to an embodiment. The finger language video recognition system according to an embodiment may include a syllable unit finger language video recognition unit 100 and a finger language video recognition model learning unit 200.

The syllable unit finger language video recognition unit 100 may receive a finger language video as an input, may recognize finger language, and may output a language text. Since a video is received as an input, the syllable unit finger language video recognition unit 100 may recognize continuously uttered finger language motions. The syllable unit finger language video recognition unit 100 performing the above-described function may include a posture information extraction unit 110 and a syllable unit finger language recognition unit 120.

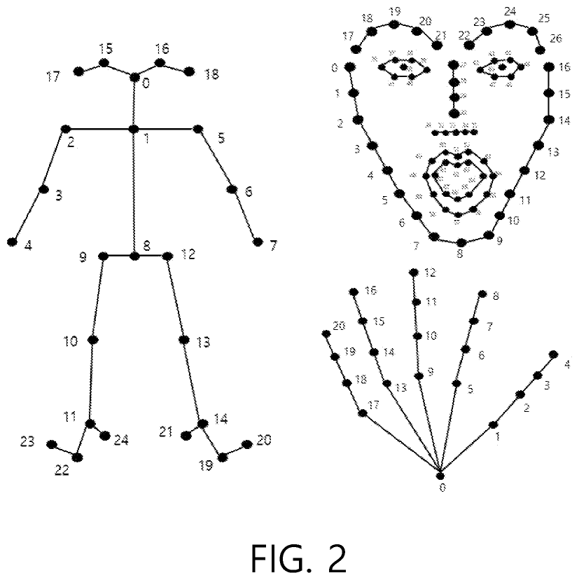

The posture information extraction unit 110 may receive the finger language video which is encoded in a certain format as an input, and may extract posture information of a speaker. The posture information of the speaker may use a skeleton model which is expressed by positions of feature points of face, hand, arms, body, etc., as shown in FIG. 2.

The syllable unit finger language recognition unit 120 is an AI model that recognizes speaker's finger language in units of syllables from speaker's posture information extracted by the posture information extraction unit 110, and outputs a language text.

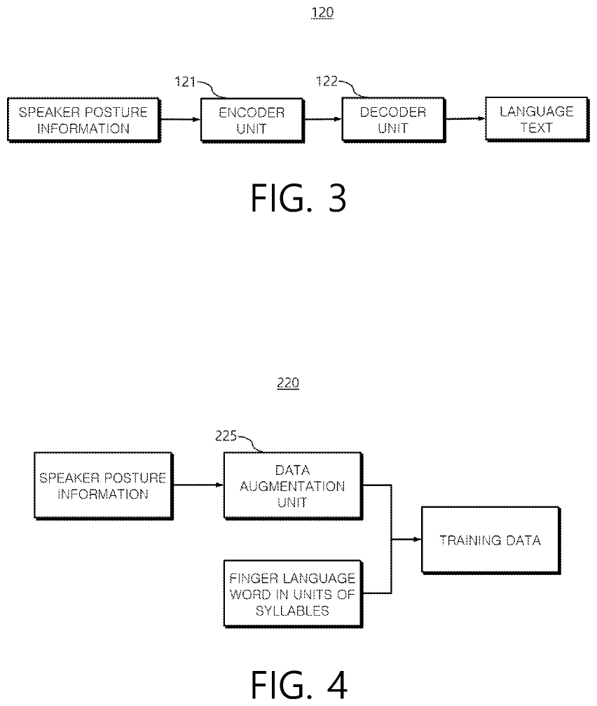

Hereinafter, the AI model will be referred to as a ‘finger language recognition model’ for convenience of explanation. FIG. 3 illustrates a structure of the finger language recognition model. The finger language recognition model has an encoder-decoder structure as shown in the drawings, and an encoder unit 121 may receive speaker's posture information as an input and may generate a code including motion information, and a decoder unit 122 may analyze encoded motion information which is generated in the encoder unit 121, and may convert the motion into a language text.

Reference is made back to FIG. 1.

The finger language recognition model learning unit 200 is configured to train the finger language recognition model, and may include a posture information extraction unit 210, a training data processing unit 220, and a training data generator 230.

The posture information extraction unit 210 may be configured to receive a finger language video for training as an input, and to extract speaker's posture information, and may be implemented by the same module as the posture information extraction unit 110 of the syllable unit finger language video recognition unit 100.

The training data processing unit 220 may process training data in a format for training the finger language recognition model of the syllable unit finger language recognition unit 120, by using the posture information extracted by the posture information extraction unit 210. Herein, the format for training the finger language recognition model may be one vector or a sequence of vectors.

FIG. 4 illustrates a structure of the training data processing unit 220. As shown in the drawing, the training data processing unit 220 includes a data augmentation unit 225 which receives speaker's posture information and augments data to train more.

The posture information augmented by the data augmentation unit 225 may be processed into training data for training the finger language recognition model of the syllable unit finger language recognition unit 120, based on combination of finger language words in units of syllables.

Reference is made back to FIG. 1.

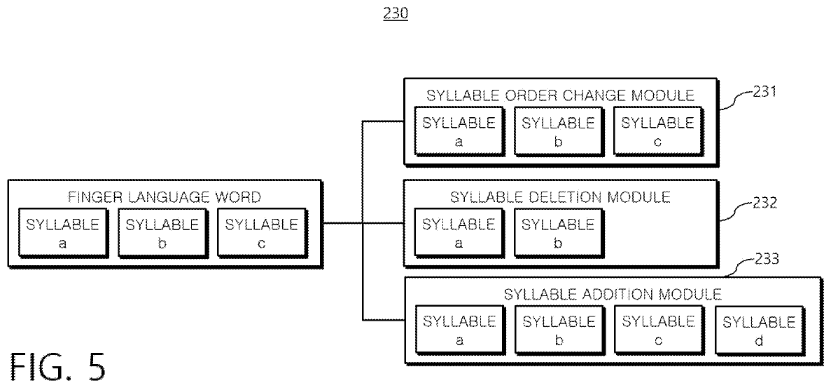

The training data generator 230 is configured to generate virtual training data by using finger language words in units of syllables in the training data. FIG. 5 is a view illustrating a structure of the training data generator 230. As shown in the drawing, the training data generator 230 may include a syllable order change module 231, a syllable deletion module 232, and a syllable addition module 233.

The syllable order change module 231 may change an order of syllables forming a finger language word. For example, as shown in FIG. 5, the syllable order change module 231 may change an order of ‘syllable a,’ ‘syllable b,’ ‘syllable c’ to an order of ‘syllable b,’ ‘syllable a,’ ‘syllable c’, and may generate a finger language video matched thereto.

The syllable deletion module 232 may delete some of the syllables forming the finger language word. For example, as shown in FIG. 5, the syllable deletion module 232 may delete ‘syllable c’ from ‘syllable a,’ ‘syllable b,’ ‘syllable c’ and may generate a finger language video matched thereto.

The syllable addition module 233 may add a new syllable to the finger language word. For example, as shown in FIG. 5, the syllable addition module 233 may add ‘syllable d’ to ‘syllable a,’ ‘syllable b,’ ‘syllable c,’ and may generate a finger language video matched thereto.

The virtual training data generated by the syllable order change module 231, the syllable deletion module 232, and the syllable addition module 233 may be processed in a format for training the finger language recognition model of the syllable unit finger language recognition unit 120 in the training data processing unit 220.

When it is determined that the training data that the training data processing unit 220 acquires from the finger language video for training is sufficient to train the finger language recognition model of the syllable unit finger language recognition unit 120, the virtual training data generated by the syllable order change module 231, the syllable deletion module 232, and the syllable addition module 233 may not be utilized for training.

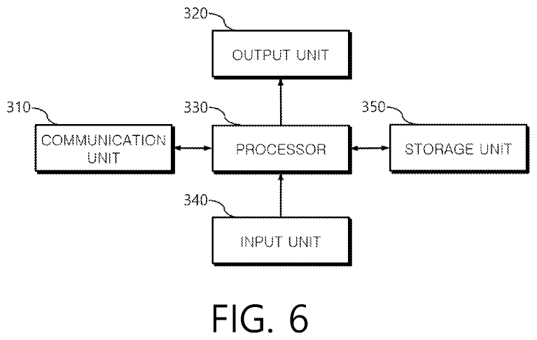

FIG. 6 is a view illustrating a hardware structure for implementing a syllable unit finger language video recognition system according to an embodiment. The system according to an embodiment may be implemented by a computing system which is established by including a communication unit 310, an output unit 320, a processor 330, an input unit 330, and a storage unit 350.

The communication unit 310 is a communication means for communicating with an external device and accessing an external network. The output unit 320 is a display for displaying a result of executing by the processor 330, and the input unit 330 is a user input means for delivering a user command to the processor 330.

The processor 330 is configured to perform functions of the syllable unit finger language video recognition system shown in FIG. 1, and includes a plurality of graphics processing units (GPUs) and a central processing unit (CPU).

The storage unit 350 provides a storage space necessary for the processor 330 to operate and function.

Up to now, the AI-based syllable unit finger language video recognition method and system have been described in detail with reference to preferred embodiments.

In an embodiment of the disclosure, finger language is recognized in units of syllables by utilizing an AI model, and a video is received as an input and continuously uttered finger language motions are recognized.

In addition, data for training a finger language recognition model is processed, and virtual data is additionally generated, so that accuracy of recognition of the finger language recognition model is enhanced.

The technical concept of the disclosure may be applied to a computer-readable recording medium which records a computer program for performing the functions of the apparatus and the method according to the present embodiments. In addition, the technical idea according to various embodiments of the present disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the art without departing from the scope of the present disclosure claimed in claims, and also, changed embodiments should not be understood as being separate from the technical idea or prospect of the present disclosure.

What is claimed is:

1. A finger language video recognition system comprising:
an extraction unit configured to extract posture information of a speaker from a finger language video; and
a recognition unit configured to recognize a finger language of the speaker from the extracted posture information of the speaker in units of syllables, and to output a text.

2. The finger language video recognition system of claim 1, wherein the posture information of the speaker is a skeleton model which is expressed by positions of feature points of face, hands, arms, and body of the speaker.

3. The finger language video recognition system of claim 1, wherein the recognition unit is configured to recognize the finger language of the speaker from the posture information of the speaker, by using an AI model which receives an input of posture information of a speaker, recognizes a finger language of the speaker in units of syllables, and outputs a text.

4. The finger language video recognition system of claim 3, further comprising a learning unit configured to train the AI model,
wherein the learning unit comprises:
an extraction unit configured to extract posture information of a speaker from a finger language video for training; and
a processing unit configured to process data into training data for training the AI model by using the extracted posture information.

5. The finger language video recognition system of claim 4, wherein the processing unit is configured to augment the posture information of the speaker, to combine with a finger language word in units of syllables, and to process data into training data.

6. The finger language video recognition system of claim 4, wherein the learning unit further comprises a generator configured to generate virtual training data by utilizing a finger language word in units of syllables.

7. The finger language video recognition system of claim 6, wherein the generator comprises a first module configured to change an order of syllables forming a finger language word, and to generate virtual training data by combining matched posture information.

8. The finger language video recognition system of claim 6, wherein the generator comprises a second module configured to delete some of syllables forming a finger language word, and to generate virtual training data by combining matched posture information.

9. The finger language video recognition system of claim 6, wherein the generator comprises a third module configured to add a new syllable to a finger language word, and to generate virtual training data by combining matched posture information.

10. A finger language video recognition method comprising:
extracting posture information of a speaker from a finger language video; and
recognizing a finger language of the speaker from the extracted posture information of the speaker in units of syllables, and outputting a text.

11. A finger language video recognition system comprising:
a recognition unit configured to recognize a finger language of a speaker from a finger language video in units of syllables, by using an AI model, and to output a text; and
a learning unit configured to train the AI model.
